(19) United States
(12) Patent Application Publication
(10) Pub. No.: US 2006/0203207 A1
(43) Pub. Date: Sep. 14, 2006

(54) Multi-dimensional keystone correction projection system and method

(76) Inventors: Roger Mitsuo Ikeda, Plano, TX (US); Jeffrey Matthew Kempf, Dallas, TX (US)

Correspondence Address: TEXAS INSTRUMENTS INCORPORATED, P O BOX 655474, M/S 3999, DALLAS, TX, 75265, US

(21) Appl. No.: 11/076,079

(22) Filed: Mar. 9, 2005

(51) Int. Cl. G03B 21/14; G03B 21/00

(52) U.S. Cl. 353/70

(57) ABSTRACT

A digital circuit, system, and method for keystone correction of a projected image utilize a digital keystone correction engine to resize a raster-scanned input image prior to projection. An image keystone correction engine uses coordinates of the corners of the image on the display device that are modified to produce a resized image for projection onto a screen. Scaling factors are generated at the corners of the image to represent image scaling along two image axes that span the area of the image to form a resized image on the display device by repositioning pixels from an uncorrected or previously resized image. The variation of the scaling factors across the image can be assumed to be linear.

### CROSS-REFERENCE TO RELATED APPLICATIONS

The following U.S. patents and/or commonly assigned patent applications are hereby incorporated herein by reference:

| Patent or | | | Attorney |
|---|---|---|---|
| Ser. No. | Filing Date | Issue Date | Docket No. |
| | Mar. 9, 2005 | | TI-39288 |
| | Mar. 9, 2005 | | TI-60026 |
| 6,712,475 | Aug. 31, 2001 | Mar. 30, 2004 | |

### TECHNICAL FIELD

The present invention relates generally to a system and method for projected image keystone distortion correction, and more particularly to a projection system and method for two-dimensional keystone correction.

### BACKGROUND

Projection systems may utilize front projection or rear projection to display video signals, which may represent still, partial motion, or full motion display images. In a digital projection system using a digital micromirror device, spatial light modulators create an image that is projected using optical lenses. The spatial light modulators generally are arranged in an electronically controlled array and may be turned on or off to create an image. The spatial light modulators may be reflective or transmissive. Common spatial light modulators include digital micromirror devices such as the Texas Instruments, Inc. “DMD™”, and liquid crystal display devices.

A rear projection system generally comprises a projection mechanism or engine contained within a housing for projection to the rear of a transmissive screen. Back-projection screens are designed so that the projection mechanism and the viewer are on opposite sides of the screen. The screen has-light transmitting properties to direct the transmitted image to the viewer.

A front projection system generally has the projection mechanism on the same side of the display screen as the viewer. An example of a front projection system is a portable front projector and a white, reflective, front-projection screen, which may be used, for example, to display presentations in meeting room settings.

Generally, the relative alignment of the projected image source and the projection surface affect the amount of keystone distortion in the displayed image. In FIG. 1, projection source 100 projects an image containing an exemplary grid of lines onto a screen 104, that may be supported by a stand 120. Displayed image 102 appears undistorted when the optical or projection axis of projection source 100 is oriented orthogonally to projection surface 104. When the alignment is orthogonal in the vertical direction, vertical grid lines 106 are displayed parallel to each other. Likewise, when the alignment is orthogonal in the horizontal direction, horizontal grid lines 108 are displayed parallel to each other. When both alignments are orthogonal, the displayed image has the same shape as the projected image.

Generally, keystone distortion results when a projector projects an image along a projection axis that is non-orthogonal to the projection surface or display. For example, as shown in FIG. 2A, when the left side 110 of projection screen 104 is tilted toward projector 100, the displayed image 112 appears larger on the right side 114 of the screen than on the left side 110 of the screen, with the image 112 generally having the shape of a keystone or trapezoid. In addition, the left side of the image is generally brighter than the right side because, in the present example, the same amount of light is concentrated in a smaller area on the left side than on the right side of the image. This example describes the projection screen as being tilted, but alternatively the projector may be misaligned to the projection screen and cause the same effect, or both axes may be misaligned to some absolute reference.

Conversely, when the left side 110 of the projection screen 104 is tilted away from the projector 100, as shown in FIG. 2B, the displayed image 116 appears smaller on the right side 114 of the screen than on the left side 110 of the screen. Similarly, when the top 118 of the projection screen 104 is tilted away from the projector 100, as shown in FIG. 2C, the displayed image 122 appears larger on the top 118 of the screen than on the bottom 119 of the screen. And when the top 118 of the projection screen 104 is tilted toward the projector 100, as shown in FIG. 2D, the displayed image 124 appears smaller at the top 118 of the screen than on the bottom 119 of the screen.

Furthermore, these effects may be combined when projection screen 104 and projector 100 are non-orthogonal in both the vertical and horizontal directions. As shown in FIG. 2E, for example, the top right corner 126 of the projection screen 104 is tilted away from the projector 100, generally causing the image 130 to combine horizontal and vertical trapezoids into an arbitrary quadrilateral which is larger in the top right corner 126 of the screen than in the lower left corner 128 of the screen.

One prior art method for correcting keystone distortion is manual correction, such as by physically moving the projector or re-aligning the projection screen to make the optical axes orthogonal to the screen. However, the system components may not be accessible for adjusting, or there may be a physical limitation on the placement of the components preventing sufficient adjustment to correct the distortion. Another prior art method is to provide adjustable optical elements in the projector that can correct keystone distortion. However, this method may only be able to correct small distortions, and can be cost prohibitive. Other, prior art methods for two-dimensional keystone correction of an image generally are computationally intensive and may be cost prohibitive for many applications.

### SUMMARY OF THE INVENTION

These and other problems are generally solved or circumvented, and technical advantages are generally achieved, by preferred embodiments of the present invention that utilize a digital keystone correction engine to perform a resizing operation on a digital image represented on a display device to provide improved appearance on a projection screen. A resized image on a display device with improved appearance after projection would typically exhibit side edges that are straight and vertical on the projection screen, and top and bottom edges that are straight and horizontal. Embodiments of the present invention utilize a digital resizing engine to perform image keystone correction in which the multi-dimensional image resizing task is performed using scaling factors derived from the location of corners of a resized image on a display device for projecting a corrected image with improved appearance onto a screen or other viewable medium. Pixels of the input image are repositioned to form the resized image by interpolating the scaling factors. The present invention can perform image resizing with three independent axes of error in the original uncorrected input image such as projector-to-screen alignment errors in pitch, yaw, and roll. Preferably, scaling factors are generated to form a resized image on the display device or other electronic medium to reposition pixels from an uncorrected input image that is to be resized to form a corrected image on a screen. Preferably, the resizing operation is performed along two axes of the image that span the area of the image. Preferably, the two-dimensional image resizing task is configured to use scaling factors at the corners of the image that represent image scaling along two axes of the image, wherein the two axes span the area of the image. Preferably, the variation of the scaling factor across the image being resized is computed to vary substantially linearly.

Another embodiment of the present invention is a method for performing digital keystone correction to a digital image prior to projection. The method includes utilizing a digital resizing engine to perform image keystone correction in which the multi-dimensional image resizing task is performed by modifying coordinates of the corners of an image on a display device to produce a corrected image on a screen with improved appearance. The method can perform image resizing with three independent axes of error in the original projected image such as projector-to-screen alignment errors in pitch, yaw, and roll. The method preferably includes using scaling factors derived from the location of corners of a resized image on a display device for projecting a corrected image with improved appearance onto a screen or other viewable medium. The method preferably includes repositioning pixels of the input image to form the resized image by interpolating the scaling factors. The method preferably includes performing the resizing operation along two axes of the image that span the area of the image. The method preferably includes configuring the two-dimensional image resizing task to use scaling factors at the corners of the image that represent image scaling along two axes of the image, wherein the two axes span the area of the image. The method preferably includes computing the variation of the scaling factors linearly across the image being resized.

In accordance with another preferred embodiment of the present invention, an image projection system including digital image keystone correction performs a resizing operation on a digital image prior to projection. Embodiments of the present invention utilize an image projection system with a resizing engine in which the multi-dimensional image resizing task is performed using coordinates of the corners of an image on a display device that are modified to produce a corrected image on a screen or other viewable medium with improved appearance. The image projection system of the present invention can perform image resizing with three independent axes of error in the original projected image such as projector-to-screen alignment errors in pitch, yaw, and roll. Preferably, scaling factors are generated in the image projection system to form a resized image on a display device to reposition pixels from an uncorrected input image that is to be resized to form a corrected image on the screen. Preferably, the resizing operation is performed along two axes of the image that span the area of the image. Preferably, the two-dimensional image resizing task is configured to use scaling factors derived from the location of corners of a resized image on a display device for projecting a corrected image with improved appearance onto a screen or other viewable medium. Pixels of the input image are preferably repositioned to form the resized image by interpolating the scaling factors. Preferably, the variation of the scaling factor across the image being resized is computed to vary substantially linearly.

An advantage of a preferred embodiment of the present invention is that the generation of a corrected image on a screen using the corners of the resized image on a display device and scale factors that vary substantially linearly across the image has significantly reduced computational requirements compared to an image correction process of the prior art.

Another advantage of a preferred embodiment of the present invention is that the image correction process can perform keystone corrections for multiple independent axes of misalignment between the projector and the screen with substantially less intensive computation than the prior art techniques.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is an illustration of a projector aligned orthogonally along three axes such as pitch, roll, and yaw to a screen;

FIG. 2A is an illustration of a projector misaligned along the horizontal axis to a screen;

FIG. 2B is an illustration of a projector misaligned along the horizontal axis to a screen;

FIG. 2C is an illustration of a projector misaligned along the vertical axis to a screen;

FIG. 2D is an illustration of a projector misaligned along the vertical axis to a screen;

FIG. 2E is an illustration of a projector misaligned along two axes to a screen;

FIG. 3A is an illustration of keystone correction of an image resulting from a projector misaligned along the horizontal axis to a screen;

FIG. 3B is an illustration of a keystone-corrected image after projection from a projector misaligned along the horizontal axis to a screen;

FIG. 4A is an illustration of an input image on a display device of lines with uniform line spacing;

FIG. 4B is an illustration of a resized image on a display device resulting in lines with non-uniform line spacing before projection;

FIG. 5 is an illustration of a raster-scanned image on a display device;

FIG. 6 is an illustration of an exemplary raster-scanned resized image on a display device illustrating areas with blackened pixels after correction for vertical projector-screen misalignment;

FIG. 7 is an illustration of an exemplary raster-scanned resized image on a display device after correction for horizontal projector-screen misalignment;

FIG. 8 is an illustration of an exemplary projected image on a screen before and after keystone correction;

FIG. 9 is an illustration of the geometry of an exemplary projected image on a screen before and after keystone correction employing the process of the present invention, including the resized image on the display device employing keystone correction of the present invention;

FIG. 10 is an illustration of the geometry of keystone correction employing a preferred embodiment process of the present invention;

FIG. 11 is a further illustration of the geometry of keystone correction employing a preferred embodiment process of the present invention; and

FIG. 12 is an illustration of a projection system configured for image keystone correction in accordance with an aspect of the present invention.

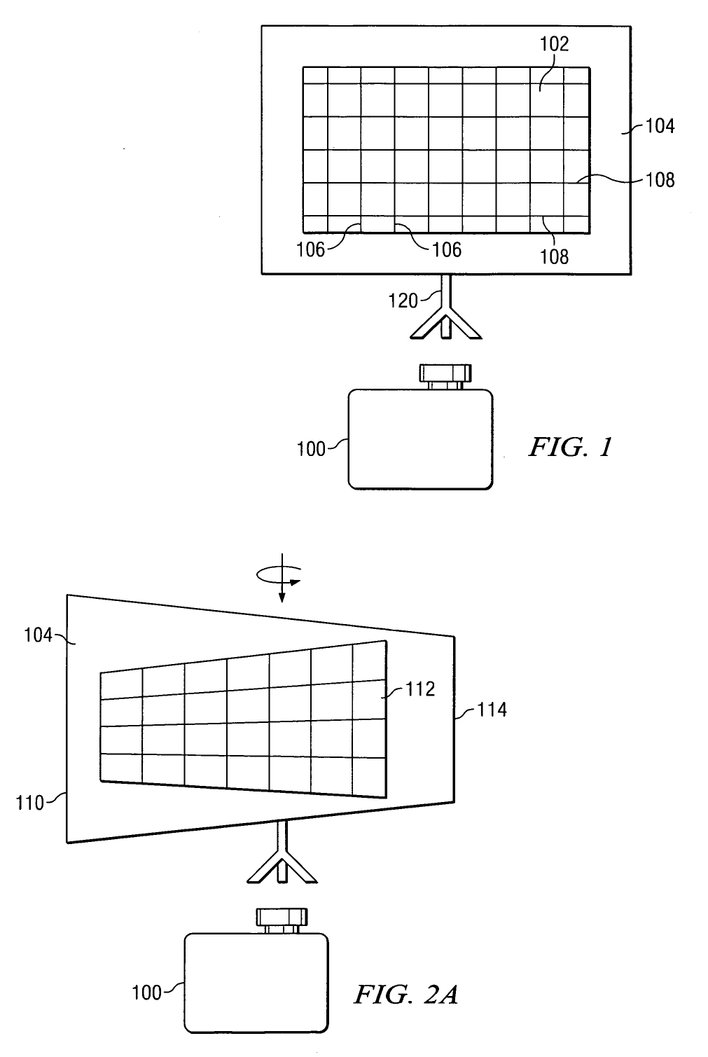

### DETAILED DESCRIPTION OF ILLUSTRATIVE EMBODIMENTS

The making and using of the presently preferred embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

The present invention will be described with respect to preferred embodiments in a specific context, namely a digital front- or rear-projection system such as one utilizing spatial light modulators and in particular digital micromirror devices such as the DMDs™ produced by Texas Instruments Incorporated. The invention may also be applied, however, to other microelectromechanical devices, other spatial light modulators such as liquid crystal displays, liquid crystal on silicon devices, grating light valves, and organic light emitting diodes. The invention may also be applied to analog video signals wherein the image is converted to a digital format for processing, or in which a digital image is converted to analog format after processing, or a combination of both.

The present invention will also be described with respect to an “input image” that may be an uncorrected input image or frame that may be part of a video stream from a camera, film, or other image data source such as an electronic medium including an electronic digital memory device that may result in keystone or rotational distortion when displayed. The input image is ordinarily coupled to a display device such as a digital micromirror device including DMDs™ or other display devices such as cathode ray tubes (“CRTs”) or liquid crystal display devices (“LCDs”). As a consequence of axis misalignment, such as an axis misalignment of a projector and a screen, a “distorted image” will be displayed on a screen or other viewable medium. When the input image is corrected by a digital keystone correction process (a digital “resizing engine”) of the present invention, a “resized” image is formed on the display device, and a “corrected” image is displayed on the screen or other viewable medium.

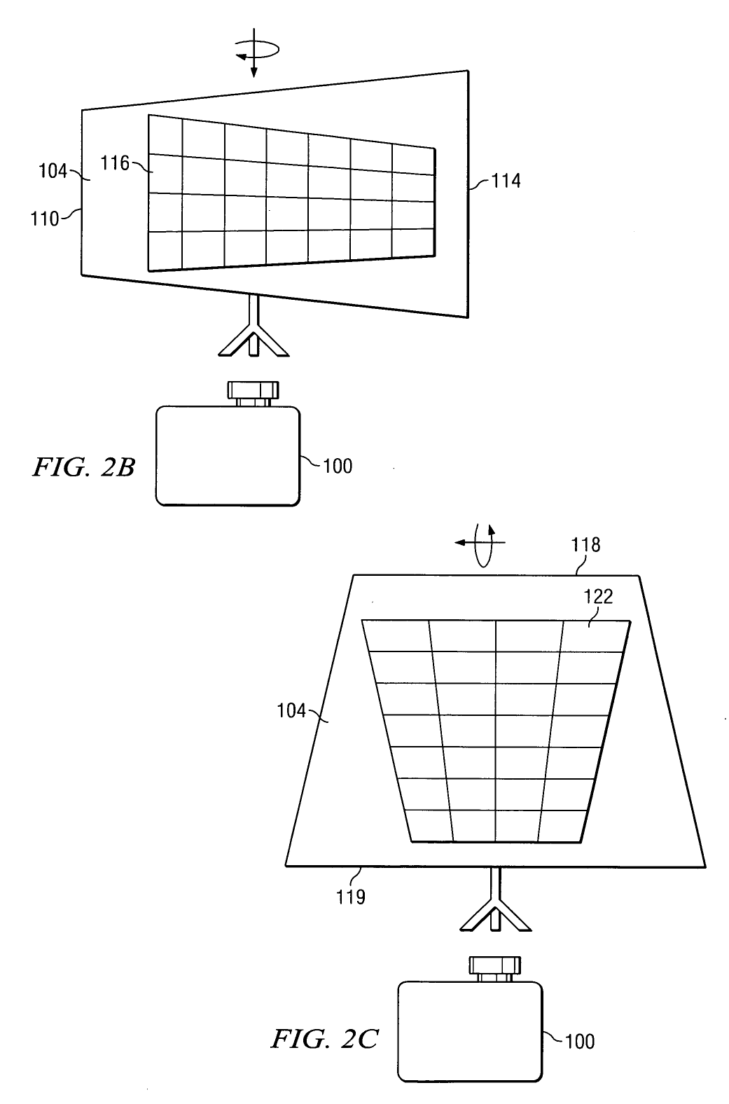

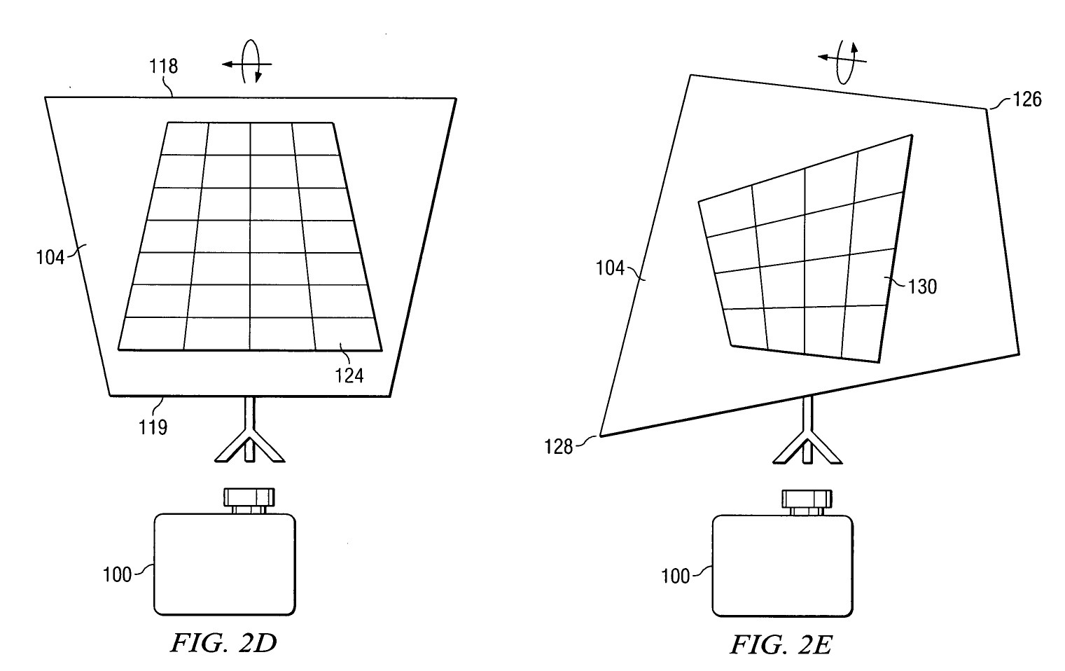

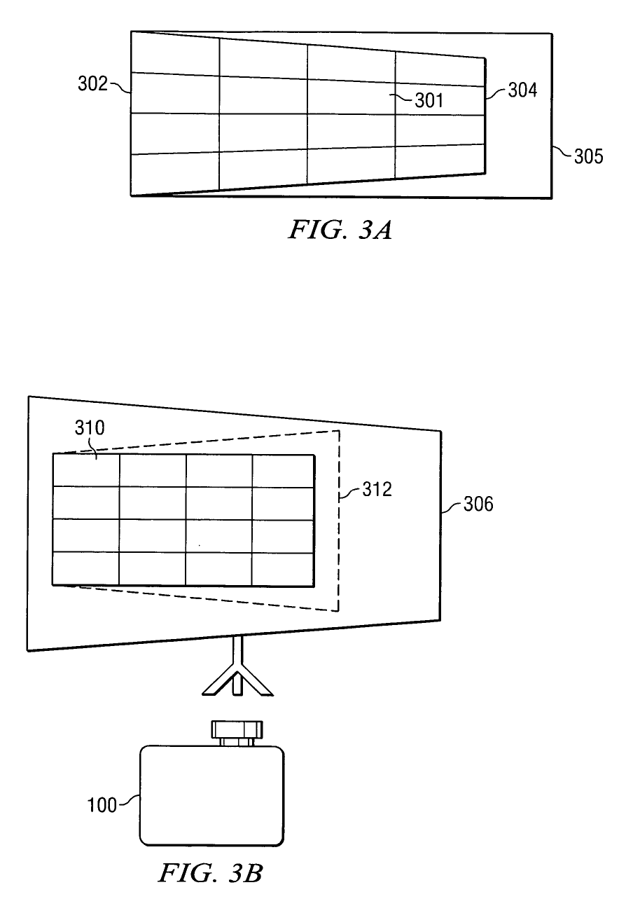

With reference again to FIG. 2A, there is shown an exemplary distorted image 112 on a screen resulting from the simple case of projection of a rectangular image formed on a display device onto a misaligned screen 104 with only its left edge 110 rotated toward the projector 100. The multi-dimensional digital keystone correction process of the present invention re-shapes each incoming image before projection so that the displayed image appears, as intended, rectangular. FIGS. 3A and 3B illustrate this process.

As illustrated on FIG. 3A, a resized image 301 on a display device 305 is decimated (reduced in size by removal of pixels) on a positional basis to form an image which when projected onto a viewable surface such as a screen misaligned with a projector will achieve the desired, visible result. A vertical scale factor, related to corrected image height divided by uncorrected image height, of the resized image on the display device before projection is reduced from the left side, 302, of the resized image, to the right side, 304. The horizontal scale factor, related to corrected image width divided by uncorrected image width, is also reduced from the left side of the image to the right side of the corrected image. The resulting projected corrected image 310 on a screen 306 misaligned with a projector 100 is illustrated on FIG. 3B, which appears to a viewer as a rectangular and undistorted image. The original input image would have been projected as the quadrilateral 312, the outline of which is illustrated on FIG. 3B with dotted lines.

The keystone correction calculation for a projected image with multiple axes of projection misalignment is a calculation dependent on a number of input variables that describe the misaligned geometry of the projector and the screen. Input variables for image resizing with the present invention rely on the coordinates of the four corners of the resized image on the display device. Each corner of the resized image can be described with two variables, such as the location of the corner along horizontal and vertical coordinate axes. Alternatively, other image parameters including parameters such as an image height-to-width ratio can be used.

A partial result of the image resizing computation is a set of local scaling factors that describe how relocation of a pixel on a display device results in relocation of the displayed pixel on the screen. Two factors can be used to describe image scaling at each corner of the image, one for each of two coordinate axes. In general, the scaling factors vary with pixel position across an image. Preferably, the scaling factor for any pixel in the image can be found from the scaling factors at the corners of the image by linear interpolation.

The image resizing computation is not dependent on the physical distance from the projector to the screen. Thus, the scaling factors may include a factor for convenience in its calculation such as the number of pixels in a line.

To explain the overall correction process, a simplified example is described first, followed by a description of the complete calculation.

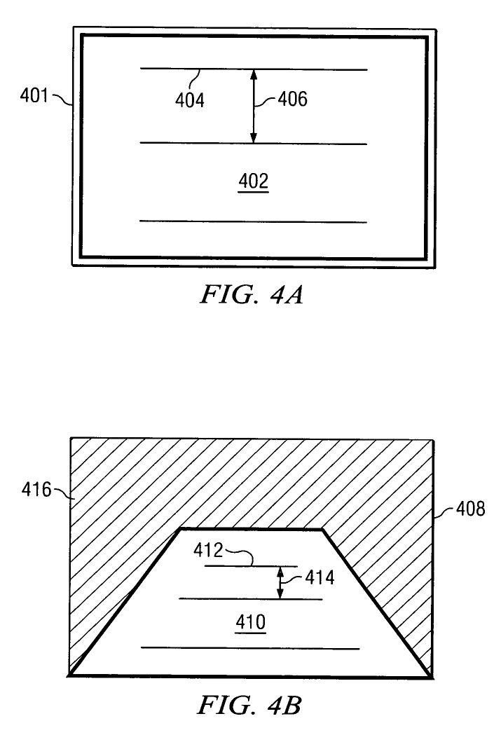

Turning next to FIG. 4A, illustrated is an exemplary mapping of pixels using a keystone resizing engine of the present invention operating on a horizontal axis of the image from an input image such as the image 402 illustrated in FIG. 4A to form a keystone-corrected “resized” image 410 on a digital micromirror device or any other display device, such as illustrated in FIG. 4B. The example illustrated for explanatory purposes of the operation of the keystone resizing engine is a simple example including only a misalignment of the projector along a vertical axis. In the more general case, three components of misalignment of a projector with a screen, such as projection errors in pitch, yaw, and roll can be corrected.

A color image is generally formed with three color components such as red, green, and blue components, i.e., “RGB components.” The image correction process described is operable for any image component. Other image representations such as a representation based on luminance and chrominance image components or a black-and-white representation are well within the broad scope of the present invention.

The raster-scanned rows commonly used in non-interleaved imaging standards such as television imaging standards are sequentially scanned pixel-by-pixel from left to right and from top to bottom. In one commonly used high-definition television standard, there are 1080 rows and 1920 pixels in each row. In the United States, such an image is scanned 60 times per second to provide synchronization with the ac power-line frequency. The uncorrected input image 402, illustrated in FIG. 4A, would ordinarily substantially fill the image space of a display device such as a digital micromirror device.

The resized image 410 is illustrated in FIG. 4B and occupies only a portion of the image space of the display device 408, and thus requires a “decimation” or pixel removal process for its creation. Remaining portions of the resized image, such as the area 416, are blackened so that they are not visible to a viewer when projected onto a screen. The even spacing between lines of an image such as represented by line spacing 406 is changed linearly across the image, resulting, for example, in the contracted line spacing such as line spacing 414 as illustrated in FIG. 4B corresponding to the uncorrected input image 402 illustrated in FIG. 4A.

The resized image 410 on the display device 408 of FIG. 4B is constructed from rows of pixels, such as the sample image line 404 in the uncorrected input image in FIG. 4A, to produce the sample image line 412 in the resized image on the display device in FIG. 4B. The rows of any image on a display device and the pixels within these rows are uniformly spaced to conform with the ordinary design of display devices such as DMDs™. However, the pixels in the uncorrected input image are mapped into unevenly spaced locations in the corrected image on the display device. Nonetheless, the individual lines and pixels in the corrected image are also necessarily evenly spaced, again to conform to the ordinary spacing of pixels in display devices.

To reduce the numerical computation in the process that maps the original uncorrected input image into an image corrected for keystoning, a simplification is made in the calculation by using image scaling factors that preferably change only linearly across the image. A local scaling factor is effectively a “derivative” representing how a small change in the location of a pixel on the display device results in a small change in the location of the displayed pixel on the screen. This is relative to a scale factor of 1.0 that applies when the optical axis is orthogonal to the screen and no keystone correction is necessary. This preferred simplification does not result in any noticeable loss of displayed image quality or in distortions such as bowed sides of the image or stair-stepped lines. Before the image can be corrected, the location of the four corners of the resized image on the display device must be supplied to the correction process from a separate source such as by a operator using a mouse or depressing buttons to locate the corners of the resized image on the display device, and may include displaying icons such as small crosses to identify where the corners of a corrected image projected onto a screen will be located.

The horizontal scaling factor can change from pixel to pixel as determined from the input parameters to the process. The decimation process preferably can only produce fewer pixels in the correction image, resulting in a smaller corrected image on the digital micromirror device or other display device; if image enlargement were also optionally performed, portions of the resulting resized image might fall outside the physical boundaries of the display device and not be displayed. Image enlargement or reduction on the projection screen, if necessary, can also be performed by relatively simple optical means such as by a zoom lens. The keystone correction process can be structured to correct a rotational misalignment of the projector, which alternatively can be corrected by a mechanical rotation and displacement of the projector or the display device.

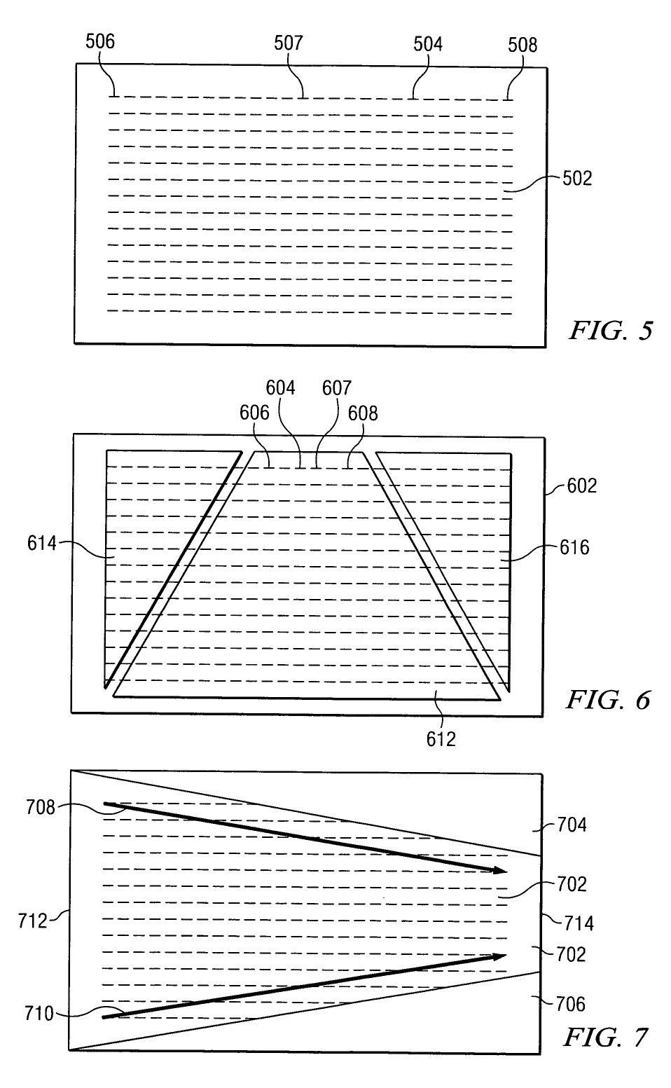

Turning now to FIG. 5, illustrated is a raster-scanned image 502 on a display device to be resized by the image resizing engine for the single-axis error example presently being discussed with only vertical misalignment between the projector and the screen. The image resizing engine maps corrected pixels line-by-line from the uncorrected input image to the resized image on the display device. For example, the three pixels 506, 507, and 508 illustrated in FIG. 5, representing pixels at the left end, middle, and right end of the first line 504 of the uncorrected input image, are mapped into the pixels 606, 607, and 608 in the first line 604 of the resized image on the display device illustrated in FIG. 6. Pixels can be dropped by this mapping process, i.e., pixels can be “decimated” but not “interpolated”, because a line of pixels preferably can only be shortened.

The resulting resized image on the display device 602 as illustrated in FIG. 6 includes blackened areas 614 and 616 that replace areas of the image on the display device that would ordinarily be occupied by portions of the uncorrected input image.

Next, an overview of vertical keystone resizing of the present invention is given. Again, a simple example is used for explanatory purposes wherein in this instance only a misalignment of the projector along a horizontal axis has been made. Turning now to FIG. 7, a mapping of pixels is illustrated from an uncorrected input image, such as the image 402 of FIG. 4A, to form a resized image 702 that is corrected for keystoning for projection such as from a digital micromirror device or other display device. On the left edge 712 of this exemplary image no decimation is required, and the image fills the vertical dimension of the display device with a scale factor of unity. On the right edge 714 of the resized image, a decimation process is required to reduce the bandwidth of the signal along the vertical dimension by about 60% for the present example, since the image appears to fill only about 40% of the vertical dimension of the display device on the right-hand side, and therefore loses about 60% of the original image information due to the reduced number of pixels actively used for its display. The required rate of change in image information reduction is preferably linear across a horizontal dimension of the image.

Areas of the image on the display device not occupied by the resized image, such as the areas 704 and 706 illustrated in FIG. 7, are filled in black so that they are not visible on a screen when displayed. When the display memory is originally written, such as when the display device is turned on, the entire image in memory is preferably written black. The entire image in memory is also written black whenever an adjustment is made to the keystone alignment of a displayed picture such as when an operator manually depresses keystone alignment control buttons or makes an image resizing change using a mouse. A manual data input means such as buttons or a mouse is typically used to adjust the parameters supplied to the horizontal and vertical image resizing engines, but other alignment data input processes such as an automatic process configured with a CCD camera observing the displayed image or other means of sensing projector misalignment is well within the broad scope of the present invention.

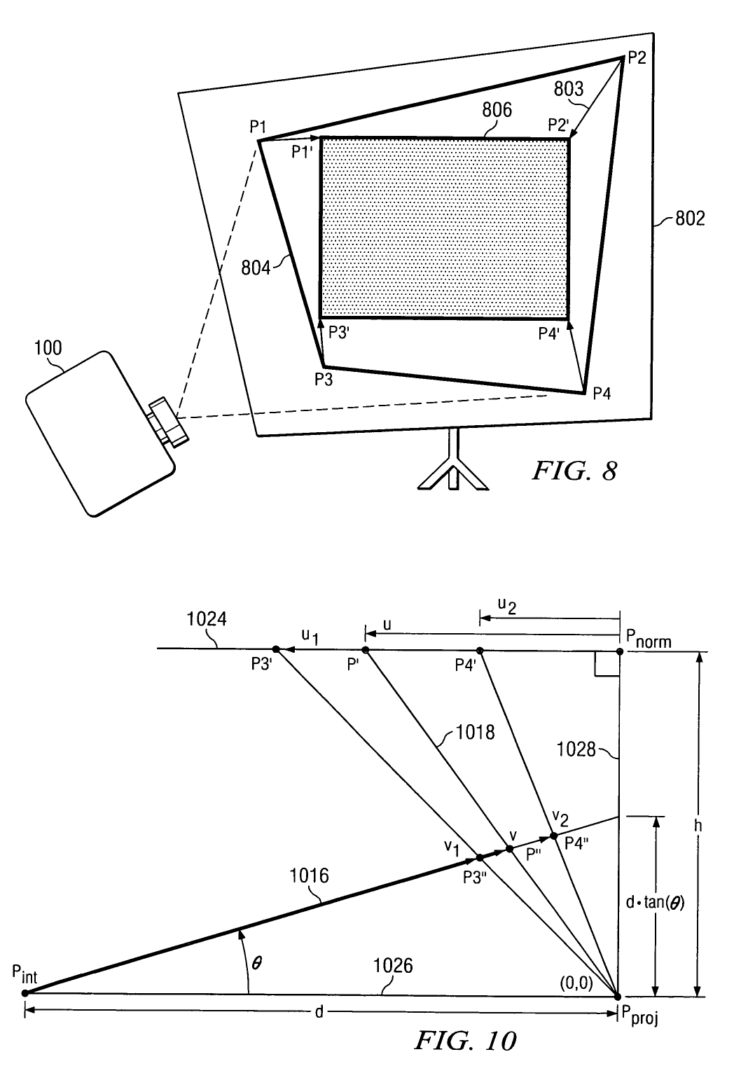

FIG. 8 illustrates an exemplary distorted image 804 projected onto a screen 802 from a projector 100, and a corrected image 806 on a screen that appears rectangular after correction employing the process or method of the present invention. The corners P1, P2, . . . , P4 of the distorted image on a screen are translated as indicated by the four arrows such as the arrow 803 on the figure to the corners P1′, P2′, . . . , P4′ of the corrected image. The translation of the four corners is in response to input parameters to the image keystone correction process that may result from an operator using, for example, a mouse or buttons to locate the corners of the correction image. The process of image keystone correction can be done in real time so that as the corners are adjusted, the image is automatically adjusted to conform to the new corner position.

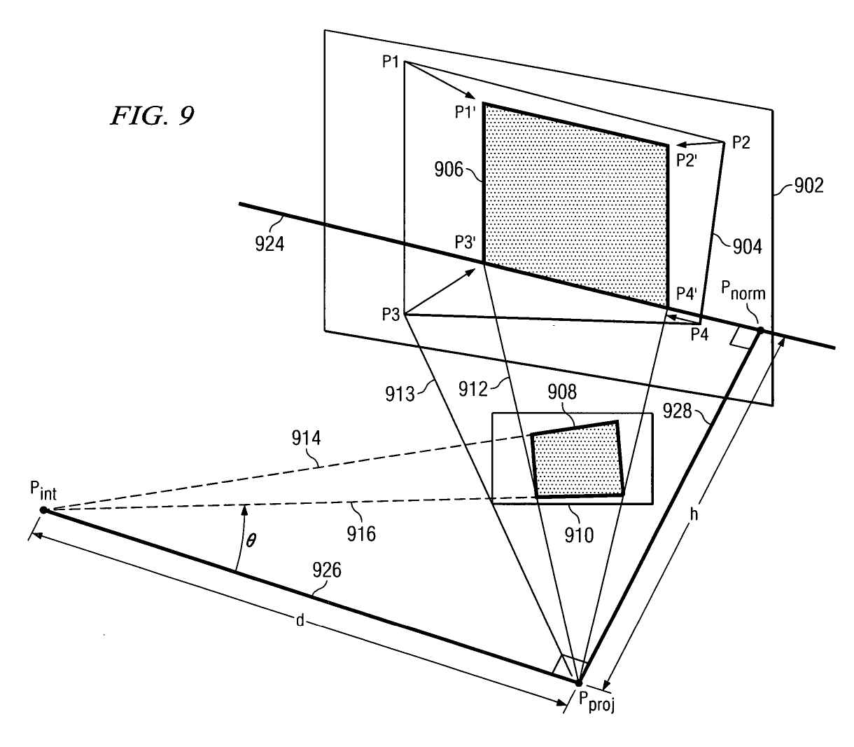

Turning next to FIG. 9, illustrated is the geometry of a corrected image 906 projected onto a screen 902 from a projector located at projection point Pₚᵣₒⱼ, which can be thought of as a point source of light. The distorted image on the screen before correction is illustrated by the quadrilateral 904 which may have four unequal sides as illustrated, and generally results from projection of the entire area of the display device onto the screen, such as indicated by the line 913. The corrected image 906 can be thought of as being back-projected onto the image area of the display device 910, and appears as the quadrilaterally shaped, resized image 908. The display device for this discussion can be thought of as a transparent film located between the projector and the screen, generally close to a point source of light. The four corners P1, P2, . . . , P4 of the distorted image on the screen are repositioned by actions of an operator or by other means to the corners P1′, P2′, . . . , P4′ of the corrected image 906.

Although an operator positions the corners of the resized image on the display device according to what is seen on the screen, it is the coordinates of the four corners of the resized image on the DMD™ or other display device that are actually adjusted, because they are the data that are accessible to the keystone correction process.

The geometry of the lower edge of an image will now be described as an example of the keystone correction process. Following the geometry of the keystone correction process illustrated in FIG. 9, a line 924 is (conceptually) constructed on the screen aligned with the lower edge of the corrected image 906. A line 926 through the projection point Pₚᵣₒⱼ is constructed parallel to the line 924 on the screen. Lines are then constructed extending the upper and lower edges of the corrected image back-projected onto the display device to form the resized image, which intersect at the point Pᵢₙₜ. The lower edge of the resized image on the display device lies in the plane of the lines 924 and 926. The intersection point Pᵢₙₜ also lies on the line 926. The distance of the projection point Pₚᵣₒⱼ from the line 924 is h as illustrated in FIG. 9, and the distance of the projection point Pₚᵣₒⱼ from the point Pᵢₙₜ is d, as also illustrated. The line 916 forms an angle θ with the line 926.

Turning now to FIG. 10, illustrated are further parameters of the geometry of the image correction process described above with reference to FIG. 9. The location of the projection point Pₚᵣₒⱼ is shown at the origin (0,0) of a rectangular x,y coordinate system, where the x-coordinate is measured horizontally on the drawing, positive to the left, and the y-coordinate is measured vertically, positive upward. The line 1024 represents a line on the screen corresponding to line 924 in FIG. 9. Similarly, the line 1016 corresponds to the line 916 illustrated in FIG. 9. The angle between the lines 1016 and 1026 is again the angle θ.

The lower left and right corners of the resized image on the display device are illustrated as the points P3″ and P4″ in FIG. 10, and an arbitrary point between them is shown as the point P″. The distances v₁ and v₂ are measures of the distances, respectively, of these points from the intersection point Pᵢₙₜ.

The points P3′ and P4′, representing the lower corners of the correction image on the screen as illustrated in FIG. 9, are shown on the line 1024 in FIG. 10 corresponding to the line 924 on FIG. 9. An arbitrary point between these two points is the point P′. The distances of these three points from the line 1028, which corresponds to line 928 on FIG. 9, is represented on FIG. 10, respectively, by the distances u₁, u₂, and u.

Knowing the input resolution of the image is the same as the resolution as the display device, and knowing the display device coordinates of the four corners, the corresponding scale factors at the four corners can be calculated. The computation of horizontal and vertical image scaling factors from the coordinates of the corners of the image on the display device are described herein below.

Turning now to FIG. 12, illustrated is projection system 1200 configured with a digital micromirror device and a keystone correction engine according to the present invention. Projection systems configured with digital micromirror devices are well known in the art, and an exemplary system is described in U.S. Pat. No. 6,712,475, entitled “Housing and Internal Layout for Compact SLM-Based Projector,” assigned to Texas Instruments Incorporated, which is referenced and incorporated herein. Projection system 1200 includes a source of illumination for the digital micrometer device provided by a lamp 1231. A color drum 1233 filters the light from lamp 1231 in the proper sequence of colors, in synchronization with the image data provided to a digital display device such as DMD™ 1232a. Color drum 1233 is a type of color wheel, having its color filters on a cylinder rather than on a flat wheel. Color drum 1233 also has additional optional elements for redirecting light, as shown by the optical path in FIG. 12. A flat color wheel could also be used. Integration optics 1238 shapes the light from the source.

Prism optics 1234 directs light from the color drum 1233 to the DMD™ 1232a, as well as from the DMD™ 1232a to projection lens 1214. The configuration of FIG. 12 has telecentric illumination optics, with prism optics 1234 having a total internal reflection prism that minimizes the size of the projection lens due to keystone correction by offset of the projection lens. However, the same concepts could be applied to non-telecentric designs, but the offset requirements will have an additional effect on the illumination angle required.

Various electrical components, as well as the DMD™ 1232a, are mounted on a printed circuit board 1232. Other components mounted on board 1232 include various memory and control devices.

The non-optical elements of the projection system include one or more fans 1235 and a power supply 1237. The power supply typically provides regulated voltages for use by circuit elements including the display device from an ac wall plug.

Scale Factor Derivation

The process of calculating the local scale factor along the bottom side of an image is described in this specification. The local scale factors along the other three sides are determined in a similar fashion. Once the local scale factors are determined along the perimeter, the local scale factor along any horizontal or vertical line can be determined using linear interpolation as described below, or by higher order means if so desired.

Referring to FIG. 10, the origin of the coordinate system is located at the bottom right corner for convenience. Line 1016 is drawn between the two bottom, operator-set points of the resized image (image 908 of FIG. 9) and is extended to the point Pᵢₙₜ. Line 1018 illustrates the mapping of a point on a bottom line of the corrected image conceptually back-projected onto the DMD™ (or other display device) and a point on a bottom line of the corrected image displayed on the screen. The variable u measures the distance of the pixel position on the bottom input line of the corrected image on the screen to the line 1028. The quantity u₁-u₂ represents the width of the input image, and can be taken to be the number of pixels in a horizontal line. The variable v is a distance measure related to the corresponding position related to the resized image on the DMD™. The actual distance from the projector to the screen is not required for the image keystone correction process of the present invention.

It is desired to calculate the change in the variable v as a function of a change in the variable u to assess how the scaling factor changes across an image, and how it depends on the alignment geometry of the projector with the screen. To calculate v as a function of u, first calculate the intersection of line 1016 and line 1026:

For line 1016:
y=x tan(θ)+d tan(θ)

For line 1026:

$$y = - \frac{h}{u} x$$

The intersection of line 1016 and line 1026 is at:

$$\begin{matrix}{y}_{int} = \frac{d tan ( θ )}{\frac{u}{h} tan ( θ ) + 1} , {x}_{int} = \frac{- \frac{u}{h} d tan ( θ )}{\frac{u}{h} tan ( θ ) + 1} \\ Let & ( 1 ) \\ {u}^{′} = u / h and {v}^{′} = v / d \\ The length {v}^{′} is \text{:} {v}^{′} = {( {( - 1 - {x}_{int} )}^{2} + {y}_{int}^{2} )}^{\frac{1}{2}} \\ {v}^{′} = {( {( \frac{1}{{u}^{′} tan ( θ ) + 1} )}^{2} + {( \frac{tan ( θ )}{u tan ( θ ) + 1} )}^{2} )}^{\frac{1}{2}} & ( 2 ) \\ Simplifying \text{:} {v}^{′} = \frac{1}{{u}^{′} sin ( θ ) + cos ( θ )} & ( 3 )\end{matrix}$$

The derivative of v′ with respect to u′ (the derivative represents the local scale factor):

$$\frac{ⅆ {v}^{′}}{ⅆ {u}^{′}} = \frac{- sin ( θ )}{{( {u}^{′} sin ( θ ) + cos ( θ ) )}^{2}} = - {v}^{′ 2} sin ( θ ) \qquad ( 4 )$$

The dependence of this result on sin(θ) must be removed since 0 is unknown. The quantities v₁, v₂, and u₁-u₂ are the only quantities that are known. From Equation 3, solving for u′:

$${u}^{′} = \frac{\frac{1}{{v}^{′}} - cos θ}{sin θ}$$

$$which gives$$

$${u}_{1}^{′} - {u}_{2}^{′} = \frac{\frac{1}{{v}_{1}^{′}} - cos θ}{sin θ} - \frac{\frac{1}{{v}_{2}^{′}} - cos θ}{sin θ}$$

Simplifying and solving for sin(θ) gives:

$$sin ( θ ) = \frac{{S}^{′}}{{v}_{1}^{′} {v}_{2}^{′}} \\ where \\ {S}^{′} = \frac{{v}_{2}^{′} - {v}_{1}^{′}}{{u}_{1}^{′} - {u}_{2}^{′}} \qquad ( 5 )$$

S is the ratio of the length of the image bottom side output (on the display device) to the input image horizontal resolution minus 1. Thus, S depends on and can be determined from the coordinates of the corners of the image being resized on the display device.

$$S = \frac{d}{h} {S}^{′} = \frac{{v}_{2} - {v}_{1}}{{u}_{1} - {u}_{2}}$$

Substituting Equation 5 into Equation 4, gives:

$$\frac{ⅆ {v}^{′}}{ⅆ {u}^{′}} = - \frac{{v}^{′ 2} {S}^{′}}{{v}_{1}^{′} {v}_{2}^{′}} \\ From Equation 2 , \\ \frac{ⅆ v}{ⅆ u} = \frac{h}{d} \frac{ⅆ {v}^{′}}{ⅆ {u}^{′}} = - \frac{h}{d} \frac{{v}^{′ 2} {S}^{′}}{{v}_{1}^{′} {v}_{2}^{′}} = - \frac{{v}^{2} S}{{v}_{1} {v}_{2}} \qquad ( 6 )$$

Simplifying this result gives the local horizontal scale factor SF at any distance v along the bottom edge of a corrected image relative to an image on a display device:

$$SF = \frac{ⅆ v}{ⅆ u} = - \frac{{v}^{2} S}{{v}_{1} {v}_{2}} \qquad ( 7 )$$

The quantities v₁ and v₂ are known from calculating the point Pᵢₙₜ using the coordinates of the four input corner points of the image being resized on the display device. Pᵢₙₜ is the point where the top and bottom of the user defined quadrilateral intersect (as illustrated on FIG. 9). The quantity u₁-u₂ is simply the horizontal dimension of the input image projected onto the screen minus 1, and can be set equal to the number of pixels in a line minus 1, such as “1024−1” for a horizontal resolution of 1024 pixels.

Equation 7 indicates that the scale factor can be directly calculated for the horizontal and vertical directions at each corner of the image being resized on the display device. The scale factor at intermediate points of the image can be approximated by linear interpolation from corners of the image. The same process of scale factor calculation with appropriate substitutions as is well understood in the art can be used along either the horizontal or vertical axes.

The process of forming a resized image does not depend on the actual distance from the projector to the screen. If, for example, the top and bottom lines of the corrected image back-projected onto the display device are substantially parallel, then the distance d is very large or “infinite”, and the ratio (v²)/(v₁*v₂) in Equation 7 will be unity, i.e., a scale factor will be constant across the image. Alternatively, if v₁ is substantially less than v₂, for example, because the top and bottom lines of the corrected image back-projected onto the display device intersect at a relatively short distance d from the image, then Equation 7 indicates the functional form of the variation of the scale factor across the image. For cases of practical interest where v₁ and v₂ are reasonably similar in magnitude, linear variation of the scale factor from one side of the image to the other can be used, allowing linear interpolation for the scale factor for pixels lying in the interior of the image.

Calculation of Image Scale Factors from Coordinates of Image Corners

The model of the present invention for keystone correction allows an operator to adjust the four corners of an image to form a rectangular corrected image after projection onto a screen. This example describes the calculation of the two local scale factors at each of the four corners of an image given the coordinates of the resized four corners of the image on the display device. The calculation assumes the resolution of pixels in the input image is the same as the resolution of pixels on the display device.

The horizontal resolution of the input image is Hᵣₑₛ and the vertical resolution is Vᵣₑₛ where
Vᵣₑₛ=pixel vertical resolution−1
and
Hᵣₑₛ=pixel horizontal resolution−1.

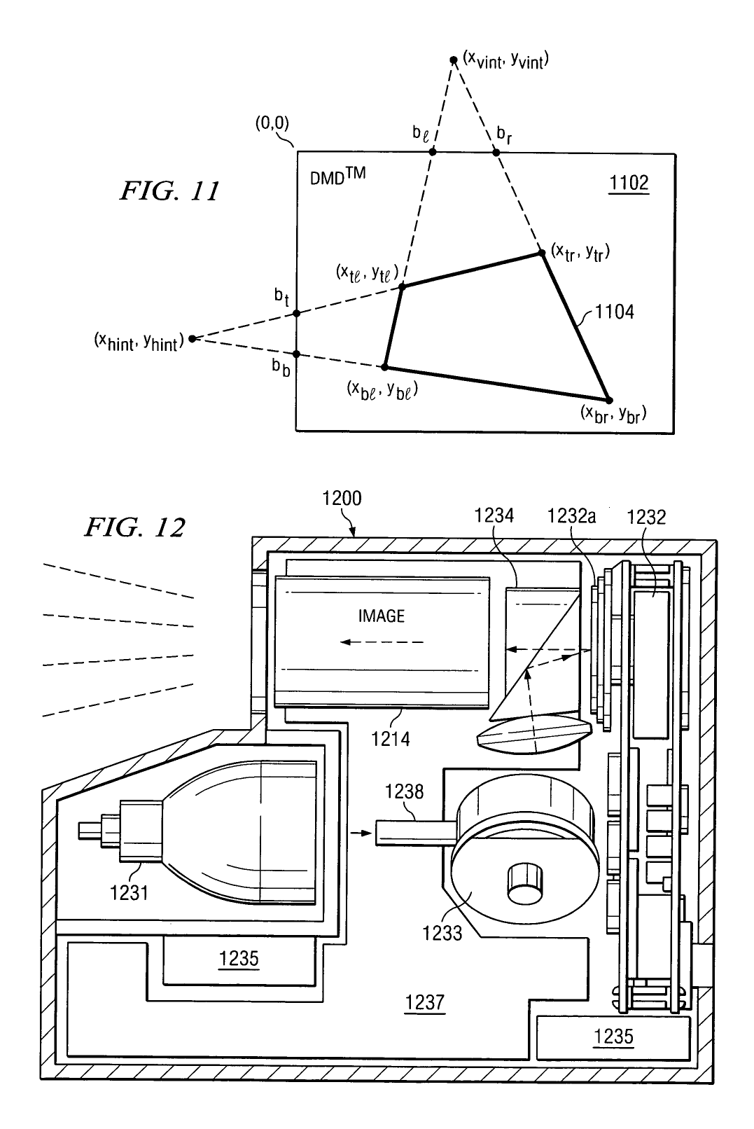

With reference to FIG. 11, an image 1104 being resized on a display device 1102 is illustrated. The four corners of the image have display device coordinates (xₜₗ, yₜₗ), (xₜᵣ, yₜᵣ), (x_{bl}, y_{bl}), and (x_{br}, y_{br}) as shown on FIG. 11:

Calculate the slopes of the top and bottom lines of the image, mₜ, m_{b}, and the reciprocal slopes of the left and right sides of the image, mₗ, and mᵣ.

$${m}_{t} = \frac{{y}_{tl} - {y}_{tr}}{{x}_{tl} - {x}_{tr}}$$

$${m}_{b} = \frac{{y}_{bl} - {y}_{br}}{{x}_{bl} - {x}_{br}}$$

$${m}_{l} = \frac{{x}_{tl} - {x}_{bl}}{{y}_{tl} - {y}_{bl}}$$

$${m}_{r} = \frac{{x}_{tr} - {x}_{br}}{{y}_{tr} - {y}_{br}}$$

Calculate the intercept points bₜ, b_{b}, bₗ, and bᵣ:
bₜ=yₜₗ−mₜxₜₗ
b_{b}=y_{bl}−m_{b}x_{bl}
bₗ=x_{bl}−mₗy_{bl}
bᵣ=x_{br}−mᵣy_{br}
Calculate the two intersection points (xₕᵢₙₜ, yₕᵢₙₜ) and (xᵥᵢₙₜ, yᵥᵢₙₜ):

$${x}_{h int} = \frac{{b}_{b} - {b}_{t}}{{m}_{t} - {m}_{b}}$$

$${y}_{h int} = {m}_{t} {x}_{h int} + {b}_{t}$$

$${y}_{v int} = \frac{{b}_{l} - {b}_{r}}{{m}_{r} - {m}_{l}}$$

$${x}_{v int} = {m}_{l} {y}_{v int} + {b}_{l}$$

Calculate the distances v_{l1, v}ₗ₂, v_{r1, v}ᵣ₂, vₜ₁, vₜ₂, v_{b1}, vₜ₂:

$${v}_{l 1} = {( {( {x}_{vint} - {x}_{tl} )}^{2} + {( {y}_{vint} - {y}_{tl} )}^{2} )}^{\frac{1}{2}}$$

$${v}_{l 2} = {( {( {x}_{vint} - {x}_{bl} )}^{2} + {( {y}_{vint} - {y}_{bl} )}^{2} )}^{\frac{1}{2}}$$

$${v}_{r 1} = {( {( {x}_{vint} - {x}_{tr} )}^{2} + {( {y}_{vint} - {y}_{tr} )}^{2} )}^{\frac{1}{2}}$$

$${v}_{r 2} = {( {( {x}_{vint} - {x}_{br} )}^{2} + {( {y}_{vint} - {y}_{br} )}^{2} )}^{\frac{1}{2}}$$

$${v}_{t 1} = {( {( {x}_{hint} - {x}_{tl} )}^{2} + {( {y}_{hint} - {y}_{tl} )}^{2} )}^{\frac{1}{2}}$$

$${v}_{t 2} = {( {( {x}_{hint} - {x}_{tr} )}^{2} + {( {y}_{hint} - {y}_{tr} )}^{2} )}^{\frac{1}{2}}$$

$${v}_{r 1} = {( {( {x}_{vint} - {x}_{tr} )}^{2} + {( {y}_{vint} - {y}_{tr} )}^{2} )}^{\frac{1}{2}}$$

$${v}_{r 2} = {( {( {x}_{vint} - {x}_{br} )}^{2} + {( {y}_{vint} - {y}_{br} )}^{2} )}^{\frac{1}{2}}$$

The scale factors in each direction at each corner of the image can be calculated as:
Top left horizontal scale factor:

$${S}_{tlh} = \frac{{v}_{t 1}}{{v}_{t 2}} \vert \frac{{v}_{t 2} - {v}_{t 1}}{{H}_{res}} \vert$$
Top left vertical scale factor:

$${S}_{tlv} = \frac{{v}_{l 1}}{{v}_{l 2}} \vert \frac{{v}_{l 2} - {v}_{l 1}}{{V}_{res}} \vert$$
Top right horizontal scale factor:

$${S}_{trh} = \frac{{v}_{t 2}}{{v}_{t 1}} \vert \frac{{v}_{t 2} - {v}_{t 1}}{{H}_{res}} \vert$$
Top right vertical scale factor:

$${S}_{trv} = \frac{{v}_{r 1}}{{v}_{r 2}} \vert \frac{{v}_{r 2} - {v}_{r 1}}{{H}_{res}} \vert$$
Bottom right horizontal scale factor:

$${S}_{brh} = \frac{{v}_{b 2}}{{v}_{b 1}} \vert \frac{{v}_{b 2} - {v}_{b 1}}{{H}_{res}} \vert$$
Bottom right vertical scale factor:

$${S}_{brv} = \frac{{v}_{r 2}}{{v}_{r 1}} \vert \frac{{v}_{r 2} - {v}_{r 1}}{{V}_{res}} \vert$$

$${S}_{blh} = \frac{{v}_{b 1}}{{v}_{b 2}} \vert \frac{{v}_{b 2} - {v}_{b 1}}{{H}_{res}} \vert$$
Bottom left horizontal scale factor:

$${S}_{blv} = \frac{{v}_{b 2}}{{v}_{b 1}} \vert \frac{{v}_{b 2} - {v}_{b 1}}{{V}_{res}} \vert$$
Bottom left vertical scale factor:

Although the present invention and its advantages have been described in detail, it should be understood that various changes, substitutions and alterations can be made herein without departing from the spirit and scope of the invention as defined by the appended claims. For example, many of the features and functions discussed above can be implemented in software, hardware, or firmware, or a combination thereof. In one example the various elements and processes described herein can be realized in an integrated circuit ASIC device. In other embodiments, the element and processes can be realized in a special or general purpose processor running appropriate routines.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A digital keystone correction engine for a projector that receives a raster-scanned input image, comprising:
an input port for receiving locations of four corners of a resized image on a digital display device; and
image correction circuitry including:
scaling factor derivation circuitry wherein horizontal and vertical scaling factors are derived from the locations of the four corners of the resized image;
interpolating circuitry wherein the horizontal and vertical scaling factors are interpolated between the corners of the resized image; and
repositioning circuitry wherein pixels in the resized image are repositioned based on the interpolated scaling factors.

2. A digital keystone correction engine according to claim 1, wherein the digital keystone correction engine corrects alignment errors of pitch and yaw between the projector and a display screen.

3. A digital keystone correction engine according to claim 1, wherein interpolation of the scaling factors is performed linearly.

4. A digital keystone correction engine according to claim 1, wherein an operator adjusts the locations of the corners of the resized image on the display device by depressing buttons.

5. A digital keystone correction engine according to claim 1, wherein the image correction circuitry is a microprocessor.

6. A digital keystone correction engine according to claim 1, wherein the digital display device is an array of deformable mirrors.

7. An image projection system that receives a raster-scanned input image, configured with a digital keystone correction engine to project a corrected image onto a screen, comprising:
a digital display device;
an input port for receiving locations of four corners of a resized image on the digital display device;
a lamp to provide illumination for the digital display device;
a power supply to provide regulated voltage for the digital display device; and
image correction circuitry including:
scaling factor derivation circuitry wherein horizontal and vertical scaling factors are derived from the locations of the four corners of the resized image;
interpolating circuitry wherein the horizontal and vertical scaling factors are interpolated between the corners of the resized image; and
repositioning circuitry wherein pixels in the resized image are repositioned based on the interpolated scaling factors to correct the image before projection onto the screen.

8. An image projection system according to claim 7, wherein the digital keystone correction engine corrects alignment errors of pitch and yaw between the projector and the screen.

9. An image projection system according to claim 7, wherein interpolation of the scaling factors is performed linearly.

10. An image projection system according to claim 7, wherein the corners of the resized image on the display device are adjusted by an operator depressing buttons.

11. An image projection system according to claim 7, wherein the image correction circuitry is a microprocessor.

12. An image projection system according to claim 7, wherein the digital display device is an array of deformable mirrors.

13. A method of performing a resizing operation for a projector for keystone correction of a raster-scanned input image, comprising:
receiving locations of four corners of a resized image on a display device;
computing horizontal and vertical scaling factors derived from the locations of the four corners of the resized image;
interpolating the horizontal and vertical scaling factors between the corners; and
repositioning pixels in the resized image based on the interpolated scaling factors; and
projecting the resized image onto a screen.

14. The method according to claim 13, including correcting alignment errors of pitch and yaw between the projector and the screen.

15. The method according to claim 13, including interpolating the scaling factors linearly.

16. The method according to claim 13, including adjusting the corners of the resized image on the display device by an operator depressing buttons.

17. The method according to claim 13, including performing the image correction with a microprocessor.

18. The method according to claim 13, including projecting the resized image onto a screen with an array of deformable mirrors.
